(19) United States
(12) Patent Application Publication
(10) Pub. No.: US 2016/0365101 A1
(43) Pub. Date: Dec. 15, 2016

(54) Enabling Event Driven Voice Interaction with a Device

(71) Applicant: Motorola Mobility LLC, Chicago, IL (US)

(72) Inventors: Kevin O. Foy, Chicago, IL (US); Eva Bills Lacivita, Grayslake, IL (US); Boby Iyer, Elmhurst, IL (US)

(21) Appl. No.: 14/739,549

(22) Filed: Jun. 15, 2015

(51) Int. Cl. G10L 25/78

(52) U.S. Cl. CPC G10L 25/78; G10L 2015/228

(57) ABSTRACT

A method includes identifying an event generated by a software application executed by a processor in a device. The event is not associated with a user interaction with the device. Without requesting or receiving user input from a user of the device, a microphone of the device is enabled for a predetermined time period after identifying the occurrence of the event to identify a user voice command. The user voice command is executed. A method includes generating an event alert notification on a speaker of a device. Without querying a user of the device, a microphone of the device is enabled for a predetermined time period after generating the event alert notification to identify a user voice command. The user voice command is executed.

### BACKGROUND

Field of the Disclosure

The disclosed subject matter relates generally to mobile computing systems and, more particularly, to enabling event driven voice interaction with a device.

Description of the Related Art

Many mobile devices allow user interaction through natural language voice commands. Typically, a user presses a button or speaks a “trigger” phrase to enable the voice communication. Often, the user desires to employ voice commands to operate in a hands free mode, such as while driving. Requiring the user to initiate the voice command mode using a button does not provide a true hands-free environment. The use of a trigger phrase requires constant use of the microphone and processing the audio stream to identify the trigger phrase, which is inefficient from a power consumption standpoint. As a result, the trigger phrase approach is only practical when the mobile device is connected to an external power supply. In addition, requiring the user to utter the trigger phrase prior to each voice command interrupts the flow of the natural language interaction.

The present disclosure is directed to various methods and devices that may solve or at least reduce some of the problems identified above.

### BRIEF DESCRIPTION OF THE DRAWINGS

The present disclosure may be better understood, and its numerous features and advantages made apparent to those skilled in the art by referencing the accompanying drawings.

FIG. 1 is a simplified block diagram of a communication system for enabling trigger-less voice interaction with a mobile device, according to some embodiments disclosed herein; and

FIG. 2 is a flow diagram of a method for enabling trigger-less voice interaction with a mobile device, according to some embodiments disclosed herein.

The use of the same reference symbols in different drawings indicates similar or identical items.

### DETAILED DESCRIPTION OF EMBODIMENT(S)

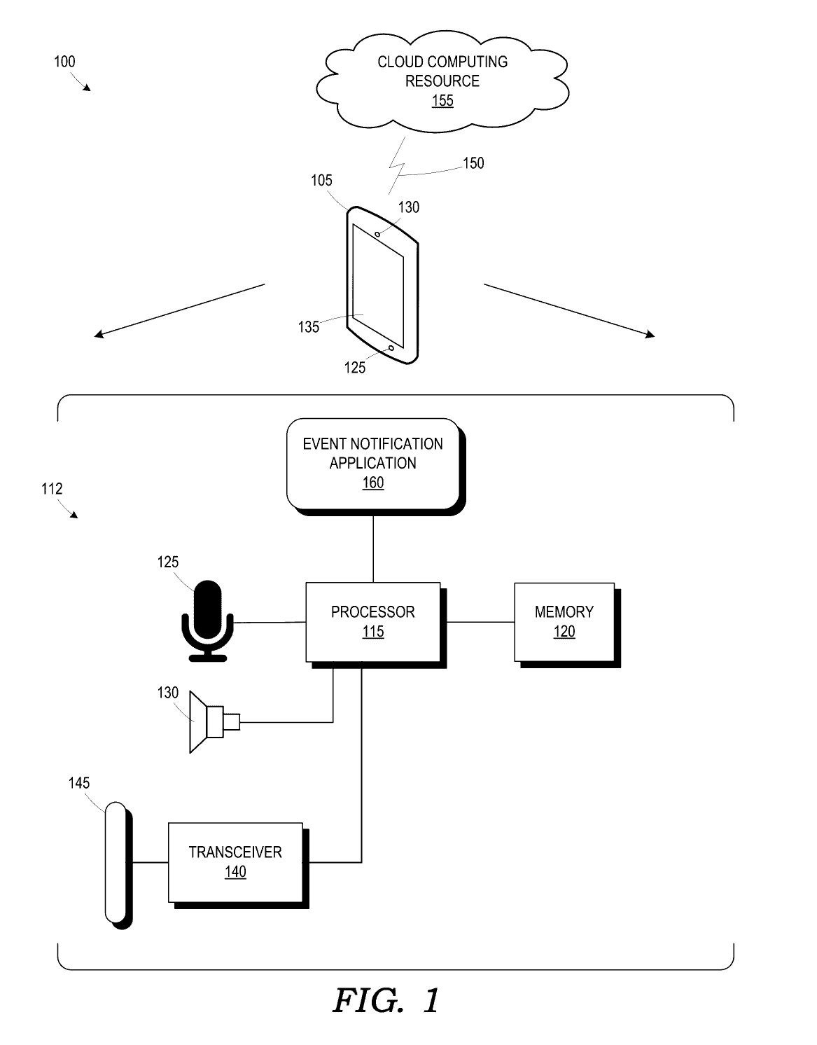

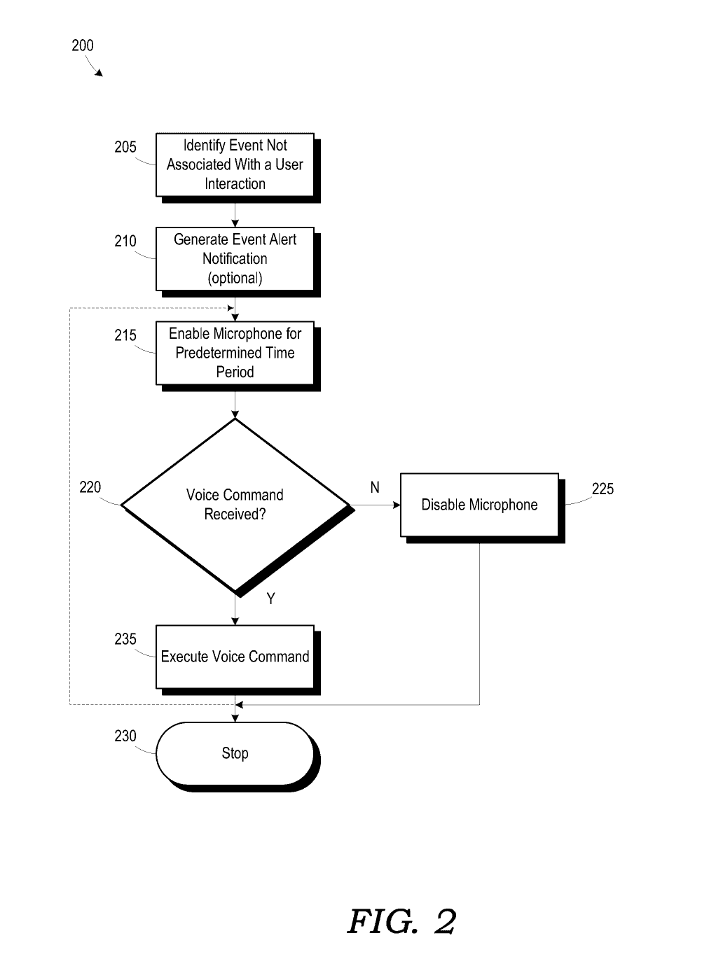

FIGS. 1-2 illustrate example techniques for enabling trigger-less voice interaction with a mobile device. After identifying a non-user initiated event generated by a software application on the device, the device activates the microphone to listen for a voice command from the user without requiring the user to initiate the voice command mode. In some cases, the device generates an alert notification, such as an audible beep, tone, or vibration, etc. and then activates the microphone to listen for a voice command. Because the triggering or initiation of the voice mode of operation is event driven rather than user driven, it is more natural for the user and more efficient from a power consumption standpoint.

FIG. 1 is a simplistic block diagram of a communications system 100 including a device 105. The device 105 implements a computing system 112 including, among other things, a processor 115, a memory 120, a microphone 125, a speaker 130, and a display 135. The memory 120 may be a volatile memory (e.g., DRAM, SRAM) or a non-volatile memory (e.g., ROM, flash memory, hard disk, etc.). The device 105 includes a transceiver 140 for transmitting and receiving signals via an antenna 145 over a communication link 150. The transceiver 140 may include one or more radios for communicating according to different radio access technologies, such as cellular, Wi-Fi, Bluetooth®, etc. The communication link 150 may have a variety of forms. In some embodiments, the communication link 150 may be a wireless radio or cellular radio link. The communication link 150 may also communicate over a packet-based communication network, such as the Internet. In one embodiment, a cloud computing resource 155 may interface with the device 105 to implement one or more of the functions described herein.

In various embodiments, the device 105 may be embodied in a handheld or wearable device, such as a laptop computer, a handheld computer, a tablet computer, a mobile device, a telephones, a personal data assistants, a music player, a game device, a wearable computing device, and the like. To the extent certain example aspects of the device 105 are not described herein, such example aspects may or may not be included in various embodiments without limiting the spirit and scope of the embodiments of the present application as would be understood by one of skill in the art.

In the device 105, the processor 115 may execute instructions stored in the memory 120 and store information in the memory 120, such as the results of the executed instructions. Some embodiments of the processor 115, the memory 120, and the microphone 125 may be configured to implement an event notification application 160 and perform portions of the method 200 shown in FIG. 2 and discussed below. For example, the processor 115 may execute the event notification application 160 to identify incoming events and implement a voice command mode without requiring the user to initiate the voice command mode. One or more aspects of the method 200 may also be implemented using the cloud computing resource 155 in addition to the event notification application 160.

FIG. 2 is a flow diagram of an illustrative method 200 for enabling trigger-less voice interaction with a device, in accordance with some embodiments disclosed herein. In one example, various elements of the method 200 shown in FIG. 2 may be implemented on the device 105. In some embodiments, the cloud computing resource 155 (see FIG. 1) may also be used to perform one or more elements of the method 200.

In method block 205, an event not associated with a user interaction is identified by the device 105. In some embodiments, the event may be an incoming communication, such as an email, text message, telephone call, video call, etc. In other embodiments, the event may be associated with a software application executing on the device, such as a music player, video player, etc. In general, the event is some action or activity not initiated by the user at the time the event occurs and is identified by the device 105.

In method block 210, an event alert notification may be generated. In some embodiments, the event alert notification is optional. The event alert notification may include an audio alert (e.g., beep, tone, ring tone, etc.), a vibration alert, or the like.

In method block 215, the microphone is enabled for a predetermined time period responsive to the identification of the event to listen for a voice command from the user.

If a voice command is not identified in method block 220 within the predetermined time period, the microphone is disabled in method block 225 and the method 200 terminates in method block 230.

If a voice command is identified in method block 220, the voice command is executed in method block 235. The nature of the voice command may depend on the type of event that resulted in the enabling of the microphone. In the case of an incoming communication, the user may instruct the device 105 with commands, such as: “Read the message”; “Answer the Call”; “Do not disturb me”, etc. The device 105 responds to the user according to the command.

In a case where the event is associated with a media player, the event may be associated with starting playing or finishing the playing of a media selection (e.g., song or video). After starting a media selection, the user may issue commands such as: “Skip”; “Turn down (or up) the volume”; “Repeat the previous song”; “Turn off the music”; “Pause the music”, etc.

In some cases, the event alert notification may not be unique to a particular event, so the cause of the event may not be evident to the user. The user may query the device 105 which a command such as, “What was that?” In response, the device 105 indicates the nature of the event by responding with a message, such as “You have a message (email, text) from John Doe, should I read it?”.

After executing the voice command, the device may return to method block 215, as indicated by the dashed line in FIG. 2 to listen for a subsequent command or the method 200 may terminate in method block 230. The particular path taken may depend on the particular nature of the voice command.

Enabling event driven initiation of voice interaction with the device improves the user experience and also increases power efficiency. The device 1-5 opportunistically listens for voice commands after identifying events likely to trigger user interactions. The user is able to engage in more natural voice communication with the device 105 without the user initiating a trigger (button or trigger phrase).

In some embodiments, certain aspects of the techniques described above may implemented by one or more processors of a processing system executing software. The method 200 described herein may be implemented by executing software on a computing device, such as the processor 115 of FIG. 1, however, such methods are not abstract in that they improve the operation of the device 105 and the user's experience when operating the device 105. Prior to execution, the software instructions may be transferred from a non-transitory computer readable storage medium to a memory, such as the memory 120 of FIG. 1.

The software may include one or more sets of executable instructions stored or otherwise tangibly embodied on a non-transitory computer readable storage medium. The software can include the instructions and certain data that, when executed by one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

A method includes identifying an event generated by a software application executed by a processor in a device. The event is not associated with a user interaction with the device. Without requesting or receiving user input from a user of the device, a microphone of the device is enabled for a predetermined time period after identifying the occurrence of the event to identify a user voice command. The user voice command is executed.

A device includes a microphone and a processor coupled to the microphone. The processor is to identify an event generated by a software application executed by a processor in a device. The event is not associated with a user interaction with the device. Without requesting or receiving user input from a user of the device, the processor is to enable the microphone for a predetermined time period after identifying the event to identify a user voice command and execute the user voice command.

A method includes generating an event alert notification on a speaker of a device. Without querying a user of the device, a microphone of the device is enabled for a predetermined time period after generating the event alert notification to identify a user voice command. The user voice command is executed.

A device includes a microphone and a processor coupled to the microphone. The processor is to generate an event alert notification on a speaker of a device. Without querying a user of the device, the processor is to enable a microphone of the device for a predetermined time period after generating the event alert notification to identify a user voice command and execute the user voice command. The event alert notification may be associated with an incoming message. The event alert notification may be associated with an incoming call. The microphone may be enabled for a second time period after executing the voice command to identify a subsequent voice command.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Note that the use of terms, such as “first,” “second,” “third” or “fourth” to describe various processes or structures in this specification and in the attached claims is only used as a shorthand reference to such steps/structures and does not necessarily imply that such steps/structures are performed/formed in that ordered sequence. Of course, depending upon the exact claim language, an ordered sequence of such processes may or may not be required. Accordingly, the protection sought herein is as set forth in the claims below.

What is claimed is:

1. A method comprising:
identifying an event generated by a software application executed by a processor in a device, wherein the event is not associated with a user interaction with the device;
without requesting or receiving user input from a user of the device, enabling a microphone of the device for a predetermined time period after identifying the occurrence of the event to identify a user voice command; and
executing the user voice command.

2. The method of claim 1, further comprising generating an event alert notification responsive to identifying the event.

3. The method of claim 3, wherein the event is associated with an incoming message.

4. The method of claim 3, wherein the event is associated with an incoming call.

5. The method of claim 1, wherein enabling the microphone comprises enabling the microphone without previously generating an event alert notification responsive to identifying the event.

6. The method of claim 5, wherein the event is associated with a media player software application.

7. The method of claim 1, further comprising enabling the microphone for a second time period after executing the voice command to identify a subsequent voice command.

8. A device, comprising:
a microphone; and
a processor coupled to the microphone, wherein the processor is to identify an event generated by a software application executed by a processor in a device, wherein the event is not associated with a user interaction with the device, and without requesting or receiving user input from a user of the device, the processor is to enable the microphone for a predetermined time period after identifying the event to identify a user voice command and execute the user voice command.

9. The device of claim 8, wherein the device comprises a speaker and the processor is to generate an event alert notification using the speaker responsive to identifying the event.

10. The device of claim 9, wherein the event is associated with an incoming message.

11. The device of claim 9, wherein the event is associated with an incoming call.

12. The device of claim 8, wherein the processor is to enable the microphone comprises without previously generating an event alert notification responsive to identifying the event.

13. The device of claim 12, wherein the event is associated with a media player software application.

14. The device of claim 8, wherein the processor is to enable the microphone for a second time period after executing the voice command to identify a subsequent voice command.

15. A method, comprising:
generating an event alert notification on a speaker of a device;
without querying a user of the device, enabling a microphone of the device for a predetermined time period after generating the event alert notification to identify a user voice command; and
executing the user voice command.

16. The method of claim 15, wherein the event alert notification is associated with an incoming message.

17. The method of claim 15, wherein the event alert notification is associated with an incoming call.

18. The method of claim 15, further comprising enabling the microphone for a second time period after executing the voice command to identify a subsequent voice command.
